(19) United States
(12) Patent Application Publication
(10) Pub. No.: US 2023/0316274 A1
(43) Pub. Date: Oct. 5, 2023

(54) ACTIVITY AUTHENTICATION USING TIME-BASED ONE-TIME PASSWORD

(71) Applicant: Lenovo (Singapore) Pte. Ltd., Singapore (SG)

(72) Inventors: Igor Stolbikov, Apex, NC (US); Russell Speight VanBlon, Raleigh, NC (US)

(21) Appl. No.: 17/709,861

(22) Filed: Mar. 31, 2022

(51) Int. Cl. G06Q 20/40; H04L 9/32

(52) U.S. Cl. CPC G06Q 20/401; G06Q 2220/00; H04L 9/3239; H04L 9/3228

(57) ABSTRACT

In one aspect, a device may include at least one processor and storage accessible to the at least one processor. The storage may include instructions executable by the at least one processor to identify a time-based one-time password (TOTP) associated with an activity such as a transaction. The instructions may also be executable to authenticate the transaction via the TOTP using a public key associated with a first party to the transaction and using one or more of data related to a name of the first party to the transaction, data related to an amount of the transaction, data related to a date of the transaction, and/or data related to an account number associated with the transaction. Based on the authentication, the instructions may then be executable to process the transaction.

### FIELD

The disclosure below relates to technically inventive, non-routine solutions that are necessarily rooted in computer technology and that produce concrete technical improvements. In particular, the disclosure below relates to techniques for activity authentication using a time-based one-time password or other code.

### BACKGROUND

As recognized herein, online digital transactions and other activities are becoming more and more ubiquitous. But as also recognized herein, these digital transactions are prone to fraud and, at the very least, can lack authorization from whomever is supposed to authorize them. As further recognized herein, if certain digital information is hacked, there is no way of gaining complete control of the information again and the information can then be freely used without authorization across the Internet. There are currently no adequate solutions to the foregoing computer-related, technological problems.

### SUMMARY

Accordingly, in one aspect a device includes at least one processor and storage accessible to the at least one processor. The storage includes instructions executable by the at least one processor to identify a time-based one-time password (TOTP) associated with a transaction. The instructions are also executable to authenticate the transaction via the TOTP using a public key associated with a first party to the transaction and using one or more of data related to a name of the first party to the transaction, data related to an amount of the transaction, data related to a date of the transaction, and/or data related to an account number associated with the transaction. Based on the authentication, the instructions are then executable to process the transaction.

In various example implementations, the TOTP may be authenticated using a hash of the amount of the transaction, where the hash may be indicated in a Merkle tree accessed by the device. The Merkle tree may be a sparse Merkle tree, for example, and the public key may be identified from the sparse Merkle tree. The TOTP itself may be a six-digit TOTP in various examples.

Also in various example implementations, the TOTP may be authenticated using a first hash of the amount of the transaction as indicated in a first distributed Merkle tree and using a second hash of the amount of the transaction as indicated in a second distributed Merkle tree different from the first distributed Merkle tree.

Additionally, in some examples the transaction may be authenticated using each of the data related to the name of the first party to the transaction, the data related to the amount of the transaction, the data related to the date of the transaction, and the data related to the account number associated with the transaction.

Still further, in certain example implementations the transaction may also be authenticated using data related to a name of a second party to the transaction, where the second party may be different from the first party and where the first and second parties may be on opposing ends of the transaction.

Additionally, if desired the transaction may be authenticated using data related to a number of funds available as indicated via a Merkle tree.

Moreover, in certain example embodiments the TOTP may be a first cryptographic hash of a second cryptographic hash of the name of the first party to the transaction, a third cryptographic hash of the amount of the transaction, a fourth cryptographic of the date of the transaction, and/or a fifth cryptographic hash of the account number associated with the transaction.

In another aspect, a method includes identifying a hash associated with a transaction. The method also includes verifying the transaction via the hash using a key associated with a first party to the transaction and using one or more of data related to a name of the first party to the transaction, data related to an amount of the transaction, data related to a date of the transaction, and/or data related to an account number associated with the transaction. Based on the verification, the method then includes processing the transaction.

In certain examples, the hash may be a time-based one-time password (TOTP). Also in certain examples, the transaction may be verified using each of the data related to the name of the first party to the transaction, the data related to the amount of the transaction, the data related to the date of the transaction, and the data related to the account number associated with the transaction.

If desired, in some implementations the hash may be a first hash and the method may include accessing a sparse Merkle tree to verify the first hash using a second hash of the amount of the transaction as indicated in the sparse Merkle tree. The key may also be identified from the sparse Merkle tree in certain examples.

Still further, in some example embodiments the transaction may be a first transaction, the first transaction may be a current transaction that is the subject of the verification, and the transaction may also be verified using data related to a second transaction that is a past transaction.

Still further, in some examples the transaction may also be verified using data related to an address associated with the first party.

In still another aspect, at least one computer readable storage medium (CRSM) that is not a transitory signal includes instructions executable by at least one processor to identify a hash associated with a transaction. The instructions are also executable to authenticate the transaction via the hash using a key associated with a first party to the transaction and using one or more of data related to a name of the first party to the transaction, data related to an amount of the transaction, data related to a date of the transaction, and/or data related to an account number associated with the transaction. Based on the authentication, the instructions are then executable to process the transaction.

In certain example embodiments, the hash may be a time-based one-time password (TOTP) and the transaction may be authenticated using the TOTP and a sparse hash tree. Also in certain examples, the transaction may be a digital transaction.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example TOTP that can be used for transaction validation as represented on a check consistent with present principles;

FIG. 4 shows an example graphical user interface (GUI) that may be presented on a payee's device to verify an example TOTP that may be used for transaction validation consistent with present principles;

FIG. 5 shows an example GUI that may be presented on a payee's device responsive to successful transaction validation via a TOTP consistent with present principles;

FIG. 6 shows an example GUI that may be presented on a payor's device to generate a TOTP for transaction validation consistent with present principles;

FIG. 7 illustrates example logic in example flow chart format that may be executed by a payor device consistent with present principles;

FIG. 8 illustrates example logic in example flow chart format that may be executed by a payee device consistent with present principles; and

FIG. 9 shows an example GUI that may be presented on a display to configure one or more settings of a device/system to operate consistent with present principles.

### DETAILED DESCRIPTION

Among other things, the detailed description below relates to use of a one-time digital token such as a TOTP signature to sign checks and online transactions for payment validation and processing using zero-knowledge proof. A sparse Merkle tree with privacy indexes may be used to allow TOTP verification by independent (or interested) services. The transaction may be an e-commerce transaction, electronic funds transfer, cryptocurrency transaction, or other type of transaction.

For placement of funds data and possibly other data into the Merkle tree, zero-knowledge proofs (ZKPs) may be used (e.g., for security and privacy). Thus, data loaded into the Merkle tree can be in the form of ZKPs that allow validation of available funds without giving up specific information of the available funds to unauthorized parties. Example ZKPs that may be used include zk-SNARKS, zk-STARKS, and bulletproofs ZKPS systems.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

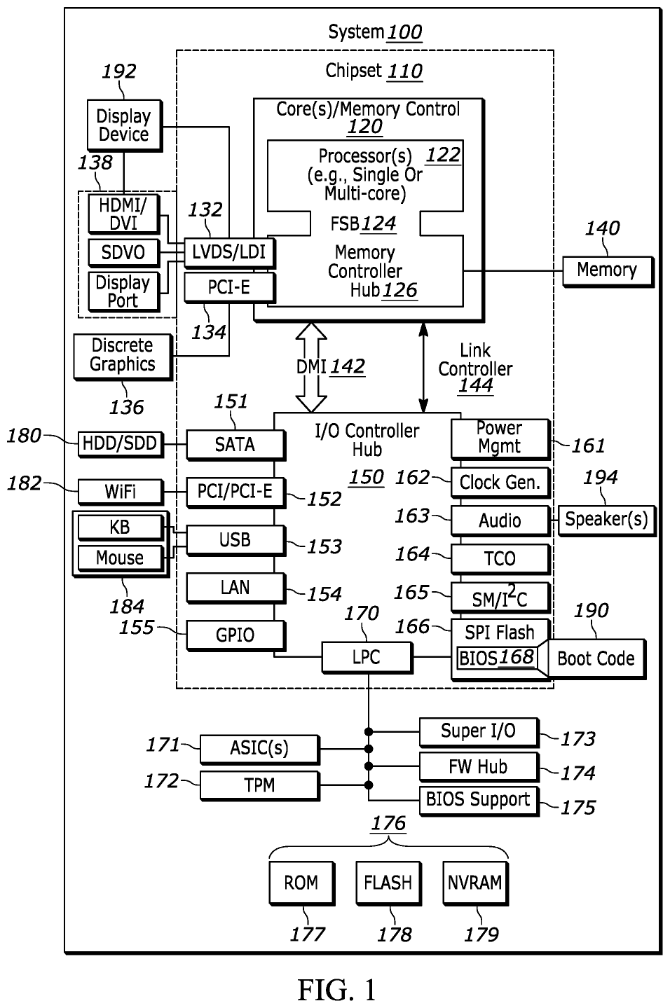

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

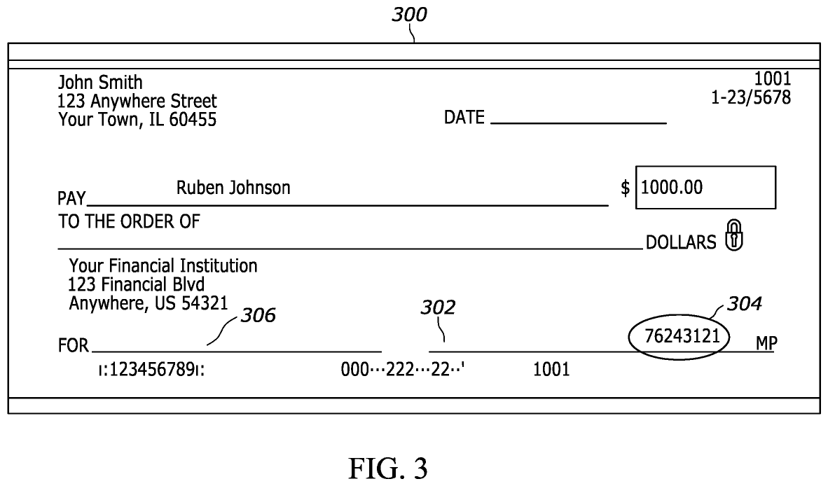

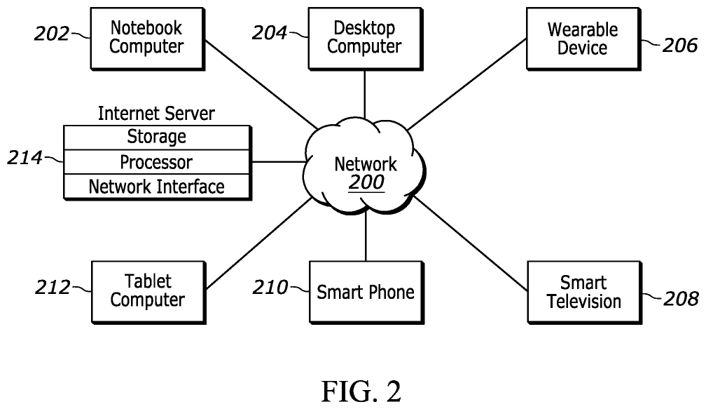

Turning now to FIG. 2, example devices are shown communicating over a network 200 such as the Internet in accordance with present principles, including to access or upload certain information to a Merkle tree and/or to communicate a digital transaction as described further below. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

Now in reference to FIG. 3, suppose a person named John Smith would like to perform a transaction where he writes a check to a payee named Ruben Johnson for $1,000. FIG. 3 shows an example check 300 that John Smith may fill in to provide the funds from his personal checking account. As also shown in FIG. 3, as part of the check's signature line 302, John Smith may handwrite or use a printer to print a time-based one-time password (TOTP) 304 or other code onto the check 300 for the transaction to be authenticated later by Ruben Johnson's bank when the check is cashed. However, further note that the TOTP 304 may be placed elsewhere on the check 300 as well, such as in the memo line 306. In either case, in some examples the TOTP 304 may be accompanied by a date (not shown) that may also be printed or handwritten onto the check, where the date indicates how long the TOTP 304 remains valid. Further note that the TOTP 304 itself may be generated by John Smith's client device based on input to a graphical user interface (GUI) like the GUI 600 of FIG. 6 (as will be described later) for John Smith to then place the TOTP 304 on the check 300.

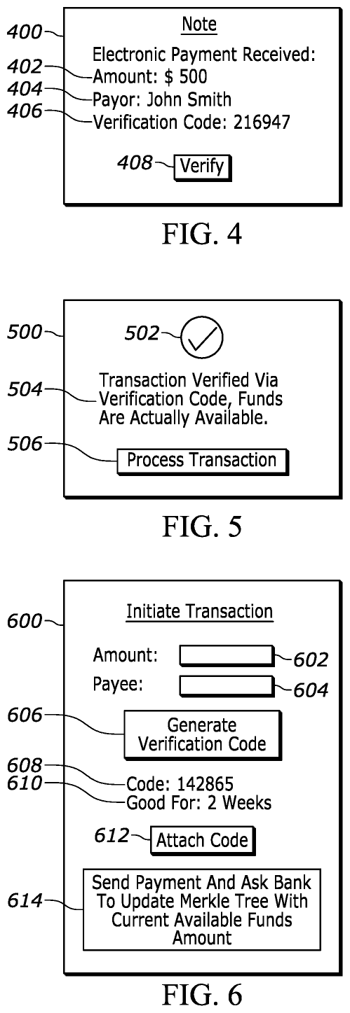

FIG. 4 shows another example. Here, assume John Smith would like to perform a digital transaction by doing an electronic funds transfer sending $500 to a person named Steve Rodriguez. PayPal, Venmo, Google Pay, Apple Pay, or another e-pay service might be used to do so. John Smith may thus input the details of the transaction to his client device for the device to then generate a TOTP to use, again through a GUI like the GUI 600 of FIG. 6 for example. Then once the transaction has been sent/initiated by John Smith, FIG. 4 shows an example GUI 400 that may be presented on the display of Steve Rodriguez's own client device.

As shown in FIG. 4, the GUI 400 may indicate various details about the digital transaction, including a transaction amount 402, payor 404, and verification code 406. The verification code 406 may be established by a TOTP or other code consistent with present principles. The code 406 may be used to authenticate that the digital transaction was actually initiated by John Smith (and thus is not fraudulent), and even to verify that John Smith actually has the requisite funds available to complete the transaction.

Accordingly, a banking/transaction application executing at Steve Rodriguez's client device, and/or a remotely-located server operated by an entity that controls Steve's account into which the funds are being transferred, may autonomously authenticate the transaction using the TOTP/code 406 and then present a GUI like the GUI 500 of FIG. 5.

Still in reference to FIG. 4 however, though not shown, the app or server may also indicate via text presented on the GUI 400 that the transaction has already been authenticated. Or if the device/server has not done so yet, as shown in FIG. 4 the GUI 400 may present a verify selector 408 for Steve Rodriguez to select to initiate the authentication himself. Then upon the transaction being authenticated, the GUI 500 of FIG. 5 may be presented as alluded to above.

Accordingly, reference will now be made to FIG. 5. As shown, the GUI 500 may include a non-text graphical icon 502 such as a green checkmark with a green circle around it indicating that the transaction has been verified/authenticated. The GUI 500 may also include text 504 indicating that the transaction has been verified via the TOTP or other code, and indicating that the device/system has verified that the funds to be transferred are actually available for transfer. Based on this verification/authentication, the transaction may be autonomously processed and completed by the payor and payee's banks or other financial institutions or, in other examples, the payee Steve Rodriguez may provide a command for the transaction to be processed and completed by selecting the selector 506 using touch input, cursor input, etc.

Before moving on to FIG. 6, further note here that if the transaction was not verified for some reason, the icon 502 may be replaced with another icon such as a red “X” with a red circle around it, along with text indicating that the transaction was not verified. In such as case, this icon and indication of verification failure may be accompanied by a selector that may be selectable to transmit an electronic message to one or both of the payor and payee's banks or other financial institutions notifying them that the transaction was not verified, which may then be used by the institution(s) for further investigation to determine if fraudulent activity has occurred.

Now in reference to FIG. 6, it shows an example GUI 600 that may be presented on the display of a client device for a payor to initiate a digital transaction and/or generate a TOTP for verifying a transaction. For example, the GUI 600 may be presented as part of a banking application executing at John Smith's client device according to the examples above, where John Smith's client device might be a smartphone, tablet, or laptop computer.

As shown in FIG. 6, the GUI 600 may include a field 602 into which an amount to be transferred may be entered using a hard or soft keyboard, voice command, etc. The GUI 600 may also include other fields for providing other information as referenced herein, including for example a payee field 604 for the payor to enter a name of the person or entity to which the payment is being made. Then once the appropriate data has been entered into the fields 602, 604, etc., the end-user may select the selector 606 to command the device/system to generate a TOTP based on the data entered into the fields 602, 604 (and any other fields that might be filled in, such as an address field for the mailing address of the payor).

Once the TOTP has been generated responsive to selection of the selector 606, the GUI 600 may dynamically update to present the generated code via indication 608 so that the end-user may then write the code on a physical check, attach it to the electronic transaction via selector 612, or enter it elsewhere electronically for an electronic funds transfer. The indication 608 may even be accompanied by an indication 610 of an amount of time or time frame during which the generated code remains valid, which in the present example is two weeks.

Note here that should the user then go back and change data entered into one or more of the fields 602, 604 (or any other fields that may be presented), the user would then have to select the selector 606 again to generate a new code that is derived from whatever data is currently entered into the fields 602, 604, etc. This is due to the TOTP being a hash of the transaction details themselves as will be described in more detail below, and so by changing or adding to the transaction details the hash would change according to the current transaction details.

FIG. 6 also shows that the GUI 600 may include a selector 614 that may be selectable by the end-user to then electronically send the payment according to the transaction details provided to the GUI 600. If desired, in some examples responsive to selection of the selector 614, the device/system may also transmit a request to the payor's financial institution to update one or more Merkle trees with a hash of an amount of funds currently available in the payor's payment account before the transaction so that this information may be verified by the payee's financial institution to ensure the payor actually has the funds available to complete the transaction. The payee's financial institution computer may thus quickly and easily verify that the payor actually has the funds available for completing the transaction rather than the payee's financial institution waiting a few days for the transaction to go through (or not) to ultimately verify as much. This in turn may help reduce certain types of fraud that can transpire by exploiting the window of time between payment deposit/receipt and payment completion.

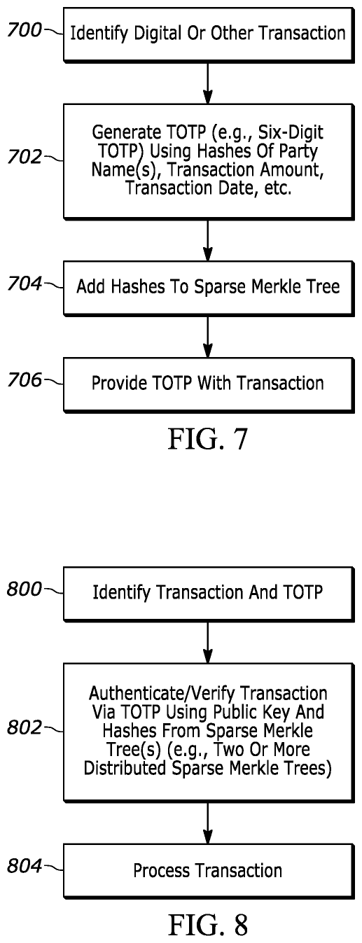

Before describing FIGS. 7 and 8 in detail, it is to be understood consistent with the description herein that a different or unique TOTP or other one-time digital token/code may be used for each transaction that a person might be seeking to complete. The TOTP may be determined via cryptographic operations using hashes of attributes known to the payor and/or payor's financial institution, including but not limited to the current transaction amount (e.g., credit or debit), previous transaction amounts (e.g., between the same parties specifically), the date of the current and/or previous transactions, payor name(s), payee/recipient name(s), and/or other transaction attributes as described herein.

Thus, an authenticated mobile application executing at the payor's client device may be used to calculate the digital token value (e.g., 6-digit TOTP). The token may thus be used in combination with private and public keys installed on the payor's client device (e.g., via the mobile application during a registration process) for transaction verification.

Cryptographic methods may therefore be used to generate the TOTP, where the TOTP may be calculated as follows in certain example embodiments: TOTP (Hashing function (attributes, ECDH (mobile_private_key, system_public_key))). The hash function that is used may be SHA-1 or another suitable hash function, including other algorithms from the SHA family or even another algorithm such as MD5, BLAKE, etc. If the resulting hash value is larger than the desired number of digits, the hash value may then be truncated using a compression function into a six-digit TOTP (or TOTP of another desired number of digits). And also note here for completeness that ECDH stands for elliptic-curve Diffie-Hellman (ECDH), a key agreement protocol that may be used consistent with present principles.

Then, to verify the payment on the other end of the transaction, the payee's own mobile application and/or payee's financial institution may calculate the symmetric function as follows: TOTP (Hashing function (attributes, ECDH (mobile_public_key, system_private_key))).

Additionally, note that in some examples a distributed verification system may be used to further ensure data integrity and robust TOTP verification. Accordingly, to ensure a distributed nature of the calculations, two or more distributed sparse Merkle trees stored at different client devices and/or servers may be used, where the TOTP is verified using each distributed Merkle tree. Notwithstanding, in other examples a centralized Merkle tree may also be used for a desired implementation. In either case, the Merkle tree(s) may store the public key of the payor along with the hashes of the attributes themselves (referred to as privacy indices below), thereby allowing any payment processor to locate the record(s) and verify the payor's TOTP/signature through zero-knowledge proof.

Thus, note here that the privacy indices can be hashes of respective payment attributes such as current transaction/payment amount, current transaction date, account number from which the current payment is being made, expiration date if the account number is a credit or debit card number for which a credit/debit card expiration date has been established, amount of funds currently available in the relevant account, first name and family name/surname of the payor, first name and family name/surname of the payee on the opposing end of the transaction, address of the payor (e.g., mailing address or business address), and other attributes as described herein. For even greater digital security, each/all of the foregoing from the preceding sentence may be used for TOTP generation and verification in certain specific example implementations.

Also for even greater digital security, another example privacy index that can be included in the Merkle tree(s) may be one or more hashes of respective amounts of one or more respective past transactions between the same two parties (and/or past transactions to which the payor themselves was a party at least). Additionally or alternatively, a single hash of all transactions between the two (or more) parties may be included in the Merkle tree(s) for enhanced digital security.

Moreover, the Merkle tree(s) may be periodically signed by the payor's financial institution or a third party verification service maintaining the Merkle tree(s) (such as once every day) to help ensure integrity, immutability and authenticity of the hashes/records that the tree(s) store, with the individual records being digitally signed by the payor's financial institution. The appropriate entity itself may be granted the ability to validate/sign the data in the Merkle tree(s) via the payor registering their client device or even financial account with the entity maintaining the Merkle tree(s) so that the information can be uploaded directly from the payor's client device and/or from the payor financial institution's own device/server. For example, the payor's client device or financial institution computer may upload hashes of previous transactions and other information to the Merkle tree(s). Furthermore, to validate that funds are actually available for the transaction being performed, the payor financial institution's computer/server may also update the Merkel tree(s) after each past completed transaction with a current account balance for the payee's institution to then validate whether the requisite funds actually currently exist in the payor's account to complete the current payment (e.g., the payor financial institution's computer may upload a hash of the current account balance of the payor's checking account or credit card available credit limit for verification via the TOTP to demonstrate that the payor actually has the requisite funds available to complete the transaction).

With the foregoing in mind, reference is now made specifically to FIG. 7. This figure shows example logic that may be executed by a device such as the system 100, a payor's client device/mobile application, and/or a device of the financial institution of the payor in any appropriate combination consistent with present principles. Note that while the logic of FIG. 7 is shown in flow chart format, other suitable logic may also be used.

In any case, beginning at block 700, the device may identify a digital or other transaction, such as based on user input from a payor to perform the transaction. The logic may then proceed to block 702 where the device may generate a TOTP, such as a six-digit TOTP in particular as this has been found to be a manageable number of digits that strikes a balance between a TOTP short enough for ease of use by the average person and still being robust enough to establish a reliable mode of verification. However, a TOTP of another number of digits may also be used as appropriate. And again note that the TOTP may be generated from hashes of the various attributes of the transaction, including but not limited to payment amount, payor address, payor name, etc.

From block 702 the logic may then proceed to block 704 where the device may also upload the hashes of the various attributes to one or more hash trees such as one or more distributed sparse Merkle trees so that the payee's mobile device/financial institution can eventually authenticate/verify the TOTP itself. Then at block 706 the device executing the logic of FIG. 7 may provide the generated TOTP with the transaction to the payee's institution (e.g., for digital transactions) and/or present the TOTP to the payor via their client device for handwriting on a check or other instrument.

Moving on to FIG. 8, this figure shows example logic that may be executed by a device such as the system 100, a payee's client device/mobile application, and/or a device of the financial institution of the payee at which a transaction is received in any appropriate combination consistent with present principles. Again note that while the logic of FIG. 8 is shown in flow chart format, other suitable logic may also be used.

Beginning at block 800, the device may identify the transaction and TOTP. For example, if the transaction is fully digital the device may receive a message, funds transfer ledger, etc. indicating the transaction being made. Otherwise, the device may identify the transaction and TOTP by, for example, executing optical character recognition (OCR) on a photograph of the check being cashed (or other tangible instrument being used as method of payment, such as a money order), where the photograph itself may have been taken by the payee end-user using their client device's camera and mobile application executing at their client device.

From block 800 the logic may then proceed to block 802 where the device may authenticate/verify the transaction via the TOTP itself using the public key of the payor/payor's client device or mobile application and also using the hashes from the Merkle tree(s) of the payor. The storage location and/or identity of the Merkle tree(s) may be indicated in the transaction details provided with the transaction, and/or may be looked up by name of the payor or other payor details. The logic may then proceed to block 804 where, assuming successful authentication/validation, the device may process or complete the transaction. Part of processing the transaction may include the payee's financial institution not just processing the payment itself but also electronically notifying the payor's financial institution that the corresponding funds are no longer available for other transactions by the payor since the current transaction is being processed by the payee's institution. In response, this may cause the payor financial institution's device to provide an updated hash to the relevant Merkle tree(s) of the current account balance after the current transaction amount has been deducted from the payor's account (or added to the payor's account, if the account was for a credit card for example).

Also note for completeness that if the authentication were not successful, at block 804 the device may decline to process or complete the transaction and may also transmit an electronic message to one or both of the payor and payee's financial institutions notifying them that the transaction was not authenticated, which may then be used by the institution(s) for further investigation to determine if fraudulent activity has occurred.

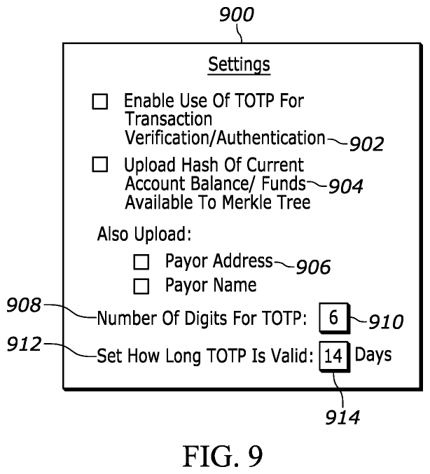

Continuing the detailed description in reference to FIG. 9, it shows an example settings graphical user interface (GUI) 900 that may be presented on a display of a client device, or even display of a server, to configure one or more settings of a transaction verification system consistent with present principles. For example, the GUI 900 may be presented on a display of the device undertaking the logic of FIG. 7 (e.g., a payor's client device or payor financial institution's own device).

The settings GUI 900 may be presented to set or enable one or more settings of the device or transaction system to operate consistent with present principles. It may be reached by navigating an app menu or a settings menu of the mobile application that is being used consistent with present principles. Also note that in the example shown, each option discussed below may be selected by directing touch or cursor input to the respective check box adjacent to the respective option.

Accordingly, as shown in FIG. 9, the GUI 900 may include an option 902 that may be selectable a single time to set or configure the device, system, software, etc. to undertake present principles for generating different TOTPs for different respective transactions to occur in the future consistent with present principles. For example, the option 902 may be selected to configure the mobile application or client device to execute the logic of FIG. 7 for multiple different digital transactions in the future.

The GUI 900 may further include an option 904 that may be selected to set or enable the device to specifically use a hash of a current account balance or amount of funds available for the TOTP and also for upload to a Merkle tree(s) (possibly along with upload timestamp) for a payee device to then verify that the funds for the transaction are actually available as described herein. Also if desired, the GUI 900 may include one or more respective additional options 906 that may be selectable to select other respective attributes that may be used to generate a TOTP consistent with present principles. Thus, any attribute discussed herein may be listed as a respective option 906, though only payor address and payor name are actually shown on the face of FIG. 9 for simplicity.

Still further, in some examples the GUI 900 may also include a setting 908 at which a desired number of digits that are to be used for the TOTPs may be established. In the present example, a user has directed numerical input to input box 910 to establish the number of digits as six.

Additionally, the GUI 900 may also include a setting 912 at which a desired length of time that the TOTP remains valid may be established. In the present example, the user has directed numerical input to input box 914 to establish the length of time as fourteen days, though another increment of time may also be used for establishing the length of time.

It may now be appreciated that present principles provide for an improved computer-based user interface that increases the functionality and ease of use of the devices disclosed herein while also improving digital security for transactions using time-limited TOTPs. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A device, comprising:
at least one processor; and
storage accessible to the at least one processor and comprising instructions executable by the at least one processor to:
identify a time-based one-time password (TOTP) associated with an activity;
authenticate the activity via the TOTP using a public key associated with a first party to the activity and using one or more of: data related to a name of the first party to the activity, data related to an amount of the activity, data related to a date of the activity, data related to an account number associated with the activity;
based on the authentication, process the activity.

2. The device of claim 1, wherein the TOTP is authenticated using a hash of the amount of the activity, the hash indicated in a Merkle tree accessed by the device.

3. The device of claim 2, wherein the Merkle tree is a sparse Merkle tree.

4. The device of claim 3, wherein the public key is identified from the sparse Merkle tree.

5. The device of claim 1, wherein the TOTP is authenticated using a first hash of the amount of the activity as indicated in a first distributed Merkle tree, and using a second hash of the amount of the activity as indicated in a second distributed Merkle tree, the first distributed Merkle tree being different from the second distributed Merkle tree.

6. The device of claim 1, wherein the TOTP is a six-digit TOTP.

7. The device of claim 1, wherein the activity is authenticated using each of: the data related to the name of the first party to the activity, the data related to the amount of the activity, the data related to the date of the activity, the data related to the account number associated with the activity.

8. The device of claim 1, wherein the activity is also authenticated using data related to a name of a second party to the activity, the second party being different from the first party, the first and second parties being on opposing ends of the activity.

9. The device of claim 1, wherein the activity is also authenticated using data related to an amount of funds available as indicated via a Merkle tree.

10. The device of claim 1, wherein the TOTP is a first cryptographic hash of one or more of: a second cryptographic hash of the name of the first party to the activity, a third cryptographic hash of the amount of the activity, a fourth cryptographic of the date of the activity, a fifth cryptographic hash of the account number associated with the activity.

11. A method, comprising:
identifying a hash associated with an activity;
verifying the activity via the hash using a key associated with a first party to the activity and using one or more of: data related to a name of the first party to the activity, data related to an amount of the activity, data related to a date of the activity, data related to an account number associated with the activity;
based on the verification, processing the activity.

12. The method of claim 11, wherein the hash is a time-based one-time password (TOTP).

13. The method of claim 11, wherein the activity is verified using each of: the data related to the name of the first party to the activity, the data related to the amount of the activity, the data related to the date of the activity, the data related to the account number associated with the activity.

14. The method of claim 11, wherein the hash is a first hash, and wherein the method comprises:
accessing a sparse Merkle tree to verify the first hash using a second hash of the amount of the activity, the second hash indicated in the sparse Merkle tree.

15. The method of claim 14, wherein the key is identified from the sparse Merkle tree.

16. The method of claim 11, wherein the activity is a first activity, the first activity being a current activity that is the subject of the verification, and wherein the first activity is also verified using data related to a second activity, the second activity being a past activity.

17. The method of claim 11, wherein the activity is also verified using data related to an address associated with the first party.

18. At least one computer readable storage medium (CRSM) that is not a transitory signal, the at least one computer readable storage medium comprising instructions executable by at least one processor to:
identify a hash associated with an activity;
authenticate the activity via the hash using a key associated with a first party to the activity and using one or more of: data related to a name of the first party to the activity, data related to an amount of the activity, data related to a date of the activity, data related to an account number associated with the activity;
based on the authentication, process the activity.

19. The CRSM of claim 18, wherein the hash is a time-based one-time password (TOTP), and wherein the activity is authenticated using the TOTP and a sparse hash tree.

20. The CRSM of claim 18, wherein the activity is a digital activity.
